(19) United States
(12) Patent Application Publication
(10) Pub. No.: US 2020/0164768 A1
(43) Pub. Date: May 28, 2020

(54) STORAGE DEVICE TEMPERATURE CONTROL ASSEMBLY

(71) Applicant: Mahle International GmbH, Stuttgart (DE)

(72) Inventors: Michael Sickelmann, Kornwestheim (DE); Thorsten Moellert, Stuttgart (DE)

(21) Appl. No.: 16/693,281

(22) Filed: Nov. 23, 2019

(30) Foreign Application Priority Data
Nov. 23, 2018 (DE) 10 2018 220 163.3

(51) Int. Cl. B60L 58/26; H01M 10/613; H01M 10/625; H01M 10/63; H01M 10/66

(52) U.S. Cl. CPC B60L 58/26; H01M 10/613; H01M 10/66; H01M 10/63; H01M 10/625

(57) ABSTRACT

A storage device temperature control assembly includes a closed duct system, through which a closed flow path of air leads, wherein an electrical energy storage device of the storage device temperature control assembly is arranged in the flow path. The arrangement of a granulate in the flow path for binding moisture from the air results in an extended service life and/or a simplified implementation of the storage device temperature control assembly. In addition, a motor vehicle includes the storage device temperature control assembly.

### CROSS REFERENCE TO RELATED APPLICATIONS

This application claims priority to German patent application DE 10 2018 220 163.3, filed Nov. 23, 2018, the entire content of which is incorporated herein by reference.

### TECHNICAL FIELD

The present disclosure relates to a storage device temperature control assembly, in particular in a vehicle, including an electrical energy storage device, the temperature of which is controlled by air during operation in the assembly.

### BACKGROUND

Electrical energy storage devices, such as accumulators, for example, require a temperature control, in particular a cooling, to maintain the effectiveness and/or in response to increasing demands and outputs. In a generic storage device temperature control assembly, the temperature control of the energy storage device takes place with the help of an airstream. For this purpose, it is generally conceivable to obtain air from the surrounding area, to control the temperature, in particular to cool it, and to apply the temperature-controlled air to the energy storage device, in order to control the temperature of the energy storage device.

In contrast, closed air circuits, in which the air for controlling the temperature of the energy storage device circulates in a closed manner, are advantageous due to an increased efficiency. In the case of such assemblies, the air circulates in a closed duct system, so that the exchange with the surrounding area is prevented, if possible. This is why the accumulation of condensate in the duct system is low, so that it is not necessary to provide the assembly, in particular the heat exchanger, with a condensate drain, and/or blockages of such a drain occur due to the small amount of condensate, which accumulates. In the case of such assemblies, the use of a condensate drain is thus forgone.

During operation and the service life of the assembly, air from the surrounding area can nonetheless reach into the closed air circuit, in particular due to unintentional leaks and/or pressure fluctuations. As a result, medium- to long-term moisture, which can condensate locally and/or which can lead to damages to the assembly, is collected in the air circuit.

A ventilation system including a closed air circuit is known from KR 101621991 B1, in the case of which an adhesive for adhering components of the ventilation system is provided with a moisture-binding agent for binding the moisture from the air.

### SUMMARY

It is an object of the disclosure to provide an improved or at least a different embodiment for an assembly of the above-mentioned type, which is a simplified implementation and/or has an increased service life.

This object is achieved by a storage device temperature control assembly and a motor vehicle including the storage device temperature control assembly.

The present disclosure is based on the general idea of arranging a granulate for binding moisture from the air, which circulates in the air circuit, in a storage device temperature control assembly including a closed air circuit for controlling the temperature of an electrical storage device. The large surface of the granulate leads to an efficient binding of the moisture in the air circuit, which can originate from the surrounding area, in particular due to unintentional leaks and/or due to pressure fluctuations in the air circuit. The granulate can furthermore be integrand into the air circuit in a simple manner, so that the storage device temperature control assembly, hereinafter also referred to in short as assembly, is implemented in a simplified manner as a whole.

According to an aspect of the disclosure, the assembly has an electrical storage device, the temperature of which is controlled during operation of the assembly. The assembly has a closed duct system, through which air circulates during operation, so that a closed flow path of air leads through the duct system and forms the closed air circuit. The energy storage device is configured for controlling the temperature in the flow path, so that the air controls the temperature of the energy storage device during operation. The temperature of the air is controlled by a heat exchanger of the assembly, which is also arranged in the flow path. According to an aspect of the disclosure, the granulate is arranged in the flow path in order to bind moisture from the air.

A closed duct system or closed flow path, respectively, is to be understood herein as such a duct system or such a flow path, respectively, for which no external air supply is provided. The closed flow path is in particular limited by the closed duct system in such a way that the flow path runs completely inside the duct system and is closed.

The electrical energy storage device can generally be of any desired design. The electrical energy storage device is in particular an accumulator.

The system according to an aspect of the disclosure can be used in any desired application. The system can in particular be used in a motor vehicle, wherein the electrical storage device can advantageously be an electrical storage device for electrically supplying components of the vehicle, in particular a drive device of the vehicle, in this case.

The heat exchanger can generally be of any desired design. The heat exchanger can in particular be electrically operated.

The heat exchanger for controlling the temperature of the air is typically integrated into a corresponding temperature control circuit of the motor vehicle.

The heat exchanger can in particular be integrated into a cooling circuit of the motor vehicle, which is used to control the temperature of an interior of the motor vehicle.

The heat exchanger is typically a heat exchanger for cooling the air. For this purpose, the heat exchanger is embodied, for example, as an evaporator.

According to an exemplary embodiment, the granulate is replaceably arranged in the duct system. This means that the granulate can be replaced, when necessary, so as to in particular continue to ensure a sufficient binding of moisture from the air. The replacement of the granulate typically takes place in response to a maintenance and/or a replacement of the electrical energy storage device. Due to the fact that the duct system has to be disassembled or opened up for this purpose, respectively, the granulate can be replaced at the same time.

According to an exemplary embodiment, the granulate is received in a container, through which the air can flow. This provides for a simplified handling of the granulate. It is furthermore prevented thereby that the granulate spreads unintentionally in the duct system.

The container can generally be of any desired design. The container can in particular be embodied so as to be flexible, for example a sack, in which the granulate is received.

It is also conceivable to embody the container as a type of cartridge, in which the granulate is received.

Typically, the container is releasably arranged in the duct system. This simplifies the attachment of the granulate in the duct system and/or the replacement of the granulate. It can be provided for this purpose that the container, together with the granulate, is replaceably arranged in the duct system.

The granulate, in particular the container, can generally be arranged at any desired position in the duct system, provided that air is guided on the granulate in such a way during the operation of the assembly that the granulate binds the moisture from the air.

Advantageous alternatives provide for the arrangement of the granulate at that position of the duct system with the highest relative moisture. It is advantageous thereby when the granulate is arranged downstream from the heat exchanger, which is typically embodied as evaporator, in the flow direction of the air.

It goes without saying that further components can also be arranged in the duct system, the temperature of which is controlled, in particular cooled, by the circulating air. This in particular includes electrical components, such as electrical converters, for example a DC-DC converter.

It goes without saying that, in addition to the assembly, a motor vehicle including such an assembly also is in the scope of this disclosure.

It goes without saying that the above-mentioned features, and the features, which will be described below, cannot only be used in the respective specified combination, but also in other combinations or alone, without leaving the scope of the present disclosure.

Exemplary embodiments of the disclosure are illustrated in the drawings and will be described in more detail in the description below, whereby identical reference numerals refer to identical or similar or functionally identical components.

### BRIEF DESCRIPTION OF THE DRAWINGS

The disclosure will now be described with reference to the drawings wherein:

FIG. 1 shows a highly simplified circuit diagram of a storage device temperature control assembly including a container storing a granulate according on an exemplary embodiment of the disclosure;

FIG. 2 shows a highly simplified circuit diagram of a storage device temperature control assembly including a container storing a granulate according on another exemplary embodiment of the disclosure,

FIG. 3 shows the container storing the granulate according to an exemplary embodiment of the disclosure; and

FIG. 4 shows the container storing the granulate according to another exemplary embodiment of the disclosure.

### DESCRIPTION OF EXEMPLARY EMBODIMENTS

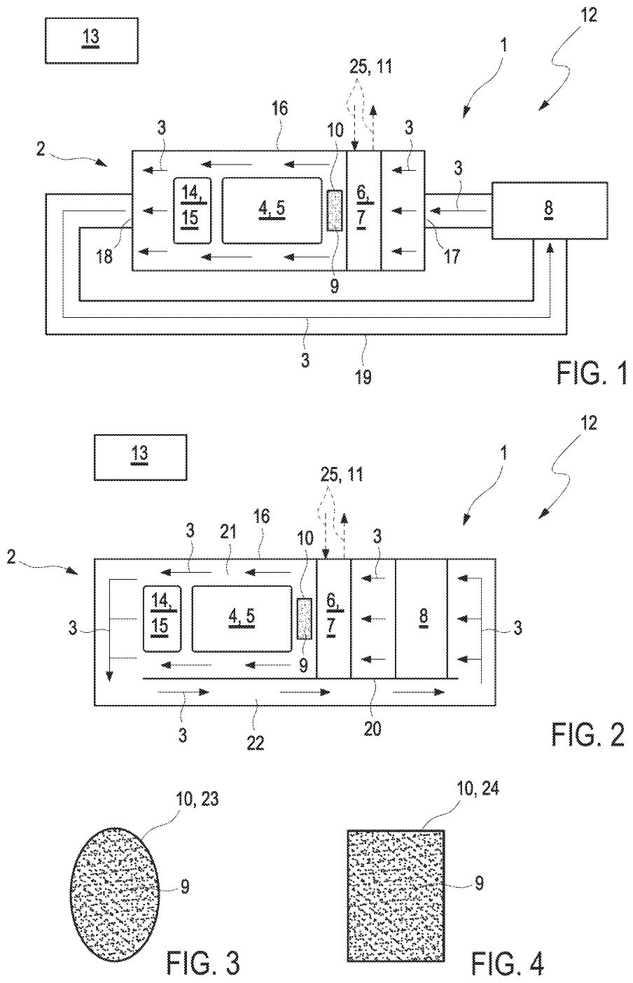

A storage device temperature control assembly 1, as shown in FIGS. 1 and 2 in a circuit diagram-like and highly simplified manner, has a closed duct system 2, through which air circulates during operation, and which limits a closed flow path 3 of the air, which is suggested by arrows. The temperature of an electrical energy storage device 4 of the storage device temperature control arrangement 1, hereinafter also referred to in short as assembly 1, is controlled by the circulating air. For this purpose, the energy storage device 4 is arranged in the flow path 3 of the air. The energy storage device 4 can be embodied, for example, as an accumulator 5. The air, which controls the temperature of the energy storage device 4, is controlled by a heat exchanger 6 of the assembly 1, which is in particular embodied as an evaporator 7 for cooling the air. For circulating the air through the closed duct system 2, the assembly 1 has a conveying device 8, which conveys the air through the duct system 2 during operation. In the shown examples, the conveying device 8 is arranged upstream of the heat exchanger 7 and downstream from the energy storage device 4 in the flow direction of the air, so that the heat exchanger 6 is arranged between the conveying device 8 and the energy storage device 4. As mentioned above, the duct system 2 is embodied to be closed in such a way that no flow of air originating from the surrounding area of the assembly 1, is provided into the duct system 2. This can nonetheless occur, in particular due to unwanted leakages and leaks and/or due to pressure fluctuations. This is why moisture can accumulate in the air during the operation of the assembly 1 or the moisture in the air can increase.

To remove the moisture from the air, the assembly 1 has a granulate 9, which is arranged in the flow path 3 and which binds the moisture from the air. In the shown exemplary embodiment, the granulate 9 is provided in a container 10, through which air can flow, so that the granulate 9 binds the moisture from the air.

In the shown exemplary embodiments, the heat exchanger 6, in particular the evaporator 7, for controlling the temperature of the air is integrated into a circuit 25, in particular cooling circuit 11, which is shown by dashed arrows, through which a temperature control medium, in particular a refrigerant, circulates during operation, and which is not illustrated otherwise.

The assembly 1 can be arranged in a motor vehicle 12, in which the electrical energy storage device 4 is used to supply components of the motor vehicle 12, for example a non-illustrated drive device. The circuit 25, in particular the cooling circuit 11, can thereby be part of the motor vehicle 12, by which the temperature of, for example, an interior 13 of the vehicle 12, is controlled, in particular cooled.

The container 10 and thus the granulate 11 are replaceably arranged in the duct system 2 in an advantageous manner such that, if necessary, they can be replaced in order to continue to ensure a binding of the moisture from the air. This replacement can take place in particular in response to a maintenance of the energy storage device 4, in the case of which a disassembly or an opening, respectively, of the duct system 2 takes place.

In the exemplary embodiments shown, a component 14, which is separate from the energy storage device 4, for example a voltage converter 15, the temperature of which is also controlled by the circulating air, in particular cooled, is further provided in the assembly 1. In the shown exemplary embodiments, the component 14 is arranged downstream from the energy storage device 4 and upstream of the conveying device 8.

In the case of the exemplary embodiment shown in FIG. 1, the energy storage device 4 as well as the heat exchanger 6 and the granulate 9 and thus the container 10 are arranged in a housing 16 of the duct system 2, which has an inlet 17 for letting the air in, and an outlet 18 for letting the air out. In this exemplary embodiment, the component 14 is also arranged in the housing 16. A return duct 19 of the duct system 2, in which the conveying device 8 is arranged or which leads through the conveying device 8, respectively, runs between the outlet 18 and the inlet 17 of the housing 16. The duct system 2 is thus embodied so as to be closed.

In the exemplary embodiment shown in FIG. 2, in contrast, the conveying device 8 is also arranged in the housing 16. The duct system 2 thus does not have a return duct 19, which is embodied as shown in FIG. 1. To the contrary, a partition wall 20 is arranged in the housing 2, which defines a forward flow duct 21 and a return duct 22 inside the housing 16, wherein, in the shown example, the conveying device 8, the heat exchanger 6, the container 10, or the granulate 9, respectively, the energy storage device 4, as well as the component 14 are arranged in the forward flow volume 21. A closed duct system is thus also realized.

FIGS. 3 and 4 show different exemplary embodiments of the container 10, which is filled with granulate 9. In the exemplary embodiment shown in FIG. 3, the container 10 is embodied so as to be flexible. The container 10 is in particular a net-like sack 23. In the exemplary embodiment shown in FIG. 4, the container 10 is embodied as a cartridge 24, in which the granulate 9 is stored.

It is understood that the foregoing description is that of the exemplary embodiments of the disclosure and that various changes and modifications may be made thereto without departing from the spirit and scope of the disclosure as defined in the appended claims.

What is claimed is:

1. A storage device temperature control assembly for a motor vehicle, the storage device temperature control assembly comprising:
an electrical energy storage device;
a closed flow path of air;
a closed duct system, in which air circulates during operation, and through which the closed flow path of air leads;
the electrical energy storage device being arranged in the closed flow path of air and being temperature-controlled by the air during the operation;
a heat exchanger arranged in the closed flow path of air which controls a temperature of the air during the operation; and
a granulate for binding moisture from the air arranged in the closed flow path of air.

2. The storage device temperature control assembly according to claim 1, wherein the granulate is replaceably arranged in the closed duct system.

3. The storage device temperature control assembly according to claim 1, wherein the granulate is provided in a container, through which the air can flow.

4. The storage device temperature control assembly according to claim 3, wherein the container is replaceably arranged in the closed duct system.

5. The storage device temperature control assembly according to claim 3, wherein the container is embodied to be flexible.

6. The storage device temperature control assembly according to claim 3, wherein the container is a sack.

7. The storage device temperature control assembly according to claim 3, wherein the container is a cartridge.

8. The storage device temperature control assembly according to claim 1, wherein the granulate is arranged downstream from the heat exchanger.

9. The storage device temperature control assembly according to claim 1, wherein the heat exchanger is an evaporator for cooling the air.

10. The storage device temperature control assembly according to claim 1, further comprising:
a conveying device for conveying the air through the closed duct system.

11. The motor vehicle comprising an interior and the storage device temperature control assembly according to claim 1.
